(19) United States
(12) Patent Application Publication
(10) Pub. No.: US 2006/0262685 A1
(43) Pub. Date: Nov. 23, 2006

(54) Disc drive apparatus, and method for timing recalibration in a disc drive apparatus

(76) Inventors: Tony Petrus Van Endert, Eindhoven (NL); Antonius Jacobus Josephus Van Den Hoogen, Eindhoven (NL); Bart Franco, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/557,963

(22) PCT Filed: May 12, 2004
(86) PCT No.: PCT/IB04/50659

§ 371 Date: Nov. 17, 2005

(30) Foreign Application Priority Data
May 19, 2003 (EP) 03101407.9

(51) Int. Cl. G11B 27/36

(52) U.S. Cl. 369/53.1

(57) ABSTRACT

A disc drive apparatus (1) is described, for writing/reading information into/from a storage medium (2), such as an optical disc. After start-up, multiple recalibration processes are executed, wherein the recalibration processes are executed more frequently when writing/reading in a region (64) close to the outer disc radius than when writing/reading in a region (62) close to the inner disc radius.

### FIELD OF THE INVENTION

The present invention relates in general to the art of storage devices such as optical storage discs. More particularly, the present invention relates in general to a disc drive apparatus for writing/reading information into/from an optical storage disc; hereinafter, such disc drive apparatus will also be indicated as “optical disc drive”.

### BACKGROUND OF THE INVENTION

As is commonly known, an optical storage disc comprises at least one track, either in the form of a continuous spiral or in the form of multiple concentric circles, of storage space where information may be stored in the form of a data pattern. Optical discs may be read-only type, where information is recorded during manufacturing, which information can only be read by a user. The optical storage disc may also be a writable type, where information may be stored by a user. For reading/writing information from/into the storage space of the optical storage disc, an optical disc drive comprises, on the one hand, rotating means for receiving and rotating an optical disc, and on the other hand optical means for generating an optical beam, typically a laser beam, and for scanning the storage track with said laser beam. Since the technology of optical discs in general, the way in which information can be stored in an optical disc, and the way in which optical data can be read from an optical disc, is commonly known, it is not necessary here to describe this technology in more detail.

In a disc drive, several operational parameters need to be calibrated, i.e. set to an optimal value for optimal performance. For example, a tilt angle of an optical lens is calibrated, a focus offset of an optical pickup unit is calibrated, a radial error amplitude is calibrated, etc. Particularly, in the case of a write operation, the optical write power is calibrated. Said parameters are commonly known to persons skilled in this art, as is the requirement for calibration. Further, calibration procedures for the above-mentioned and other parameters are known per se, and may be used in implementing the present invention. Therefore, a more detailed description of calibration procedures is not necessary here.

It is already known in practice to perform calibration procedures as part of a start-up procedure or initiation procedure, i.e. when a new disc is introduced in the disc drive, and/or when a new read/write command is given in respect of a disc already present in the drive. However, it may be that the parameter values as set during start-up calibration are no longer optimal values at a later stage of the read/write process. This may, for instance, be due to changing circumstances like changing temperature, changing read/write location on disc, etc. Therefore, it may be desirable to also perform calibration procedures at a later stage, when a write or read process is in progress. Such calibration procedures will be indicated by the phrase “recalibration”, to make a distinction from calibration during the start-up phase.

An important aspect in recalibration is its timing. On the one hand, more frequent recalibration procedures may improve the signal quality, but it involves a reduction in data throughput. On the other hand, if recalibration procedures are performed not often enough, errors may occur. Further, recalibration procedures interrupt the write or read process which is in progress, so they could affect the proper data transfer.

### SUMMARY OF THE INVENTION

The present invention relates specifically to the timing of recalibration.

It is a general objective of the present invention to provide a disc drive apparatus in which an optimal signal quality is maintained as much as possible.

It also is a general objective of the present invention to provide a disc drive apparatus in which the number of recalibration procedures performed is as few as possible.

It is a further general objective of the present invention to provide a disc drive apparatus in which recalibration procedures are performed as efficiently as possible, i.e. in which the timing of recalibration procedures for a certain parameter is determined in relation to a chance that this parameter actually needs to be recalibrated.

It is a specific objective of the present invention to provide a disc drive apparatus with a recalibration management facility which provides an efficient timing of recalibration procedures for parameters which depend on disc-location.

Some parameters depend on the location on disc where the write/read operation takes place, i.e. the radial coordinate of the current track. Examples of such parameters are, for instance, tilt and radial error amplitude. If such parameter is calibrated at a certain calibration location, it is expected that the calibration is suitable for the write/read process in the neighbourhood of this calibration location, but at larger distances from said calibration location the chances increase that the calibration is no longer suitable.

According to an important aspect of the present invention, the disc is subdivided into different adjacent radial zones, each zone being characterized by an inner zone radius and an outer zone radius. The radial distance between inner zone radius and outer zone radius is indicated as size of the zone. The inner zone radius of a next zone coincides with the outer zone radius of the adjacent previous zone. A recalibration procedure is executed on entry of a new zone.

In a manufacturing process of optical discs, an aim is to make a disc having properties which are substantially constant over the surface of the disc. Succeeding in this objective is substantially more difficult in the region of the outer edge of the disc than in the middle or inner regions of the disc. One important reason for this problem is the fact that in spin coating processes a fluid film behaves differently at the outer edge of the disc (where the disc ends) as compared to the middle or inner regions of the disc (where the disc is a contiguous surface). As a result, the chances of deviating disc properties are relatively high closer to the region of the outer edge of the disc. Also, the optimal write power is influenced.

Based on this understanding, the present invention proposes to have more frequent recalibration operations when writing or reading closer to the region of the outer edge of the disc. Or, the zones closer to the region of the outer edge of the disc have smaller size than the zones in the middle or inner regions of the disc.

Recalibration may start immediately when entering a new zone, or after fulfilment of recalibration permission conditions.

In a specific embodiment, a disc drive apparatus comprises a data engine system and a data processing system. The data engine system provides an interface between disc drive apparatus and disc, as it handles all incoming and outgoing communication between disc drive and disc. The data processing system processes the data present in incoming and outgoing signals from and to the disc, respectively, and processes the data for communication to and from a host system such as a PC, respectively. The data engine system determines the moments when a new zone is entered, i.e. the moments in time when a recalibration is desirable. If the actual recalibration is postponed until fulfilment of recalibration permission conditions, it may be that the check for such conditions is done by the data processing system.

### BRIEF DESCRIPTION OF THE DRAWINGS

These and other aspects, features and advantages of the present invention will be further explained by the following description of a preferred embodiment of the present invention with reference to the drawings, in which same reference numerals indicate same or similar parts, and in which:

FIG. 1 schematically shows a block diagram illustrating relevant parts of a disc drive apparatus;

FIG. 2 schematically shows a block diagram illustrating relevant parts of a control circuit;

FIG. 3 schematically illustrates disc zones;

FIG. 4 is a flow diagram schematically illustrating a first method of determining recalibration starting times in accordance with the present invention;

FIG. 5 is a flow diagram schematically illustrating a second method of determining recalibration starting times in accordance with the present invention.

### DESCRIPTION OF THE INVENTION

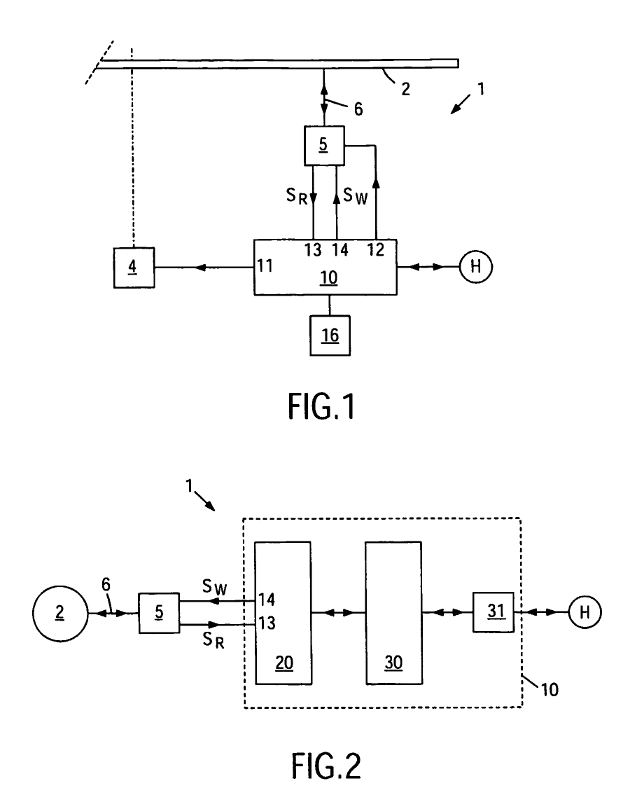

FIG. 1 schematically shows a diagram which illustrates some parts of a disc drive apparatus 1, capable of handling a disc 2. For instance, the disc 2 is an optical (including magneto-optical) disc, such as a CD, a DVD, etc. The disc drive 1 comprises a motor 4 for rotating the disc 2, and an optical pickup unit 5 for scanning tracks (not shown) of the disc 2 with an optical beam 6.

The disc drive 1 further comprises a control circuit 10, having a first output 11 for controlling the motor 4, and having a second output 12 for controlling the optical pickup unit 5. The control circuit 10 further has a data input port 13 and a data output port 14. In a reading mode, the data input port 13 receives a data read signal S_{R} from the optical pickup unit 5. In a writing mode, the control circuit 10 provides a data write signal S_{W} at its data output port 14. The control circuit 10 further has a data communication port 15 for data communication with a host system, generally indicated at H. The host system H may for instance be a PC or the like. The disc drive 1 may be separate from the host 1, communicating over a long-distance communication path, or it may be built-in in the host H.

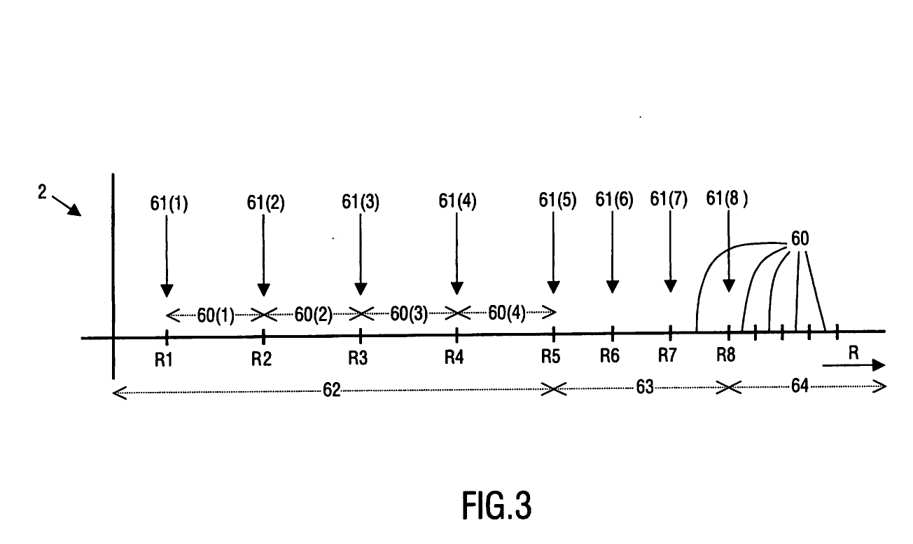

FIG. 3 schematically illustrates a storage area of a disc 2. The horizontal axis represents position of a storage location, or track, expressed as a radius R from the rotational axis 7 of the disc 2.

When the disc drive 1 is started, for instance when a new disc 2 is introduced into the drive, a start-up procedure is executed, which includes a calibration procedure for certain parameters, as is known per se. This calibration procedure is executed at a certain calibration location, which may be a fixed location, and which by way of example is indicated at L_{rec} in FIG. 3. Some of the calibrated parameters depend on location, i.e. radius R. Examples of location-depending parameters are tilt and radial error.

Thus, it is desirable to perform a recalibration of the location-depending parameters, or at least one of the parameters belonging to the group of location-depending parameters, some time after start of a read operation or write operation, when the distance between the calibration location and the current read/write location increases. In the case of prolonged duration of such read operation or write operation, it is desirable that such recalibration procedure is repeated regularly.

According to an important aspect of the present invention, the disc 2 is subdivided into zones 60. The borderline between two adjacent zones 60 will be indicated as a zone borderline 61. In the following, individual zones 60 and borderlines 61 will be distinguished by an index i.

In FIG. 3, subsequent zone borderlines 61 are indicated at radius R1, R2, R3, etc. Each zone has an outer radius and an inner radius: in FIG. 3, the zone 60(2) has an inner zone borderline 61(2) at radius R2 and an outer zone borderline 61(3) at radius R3, which is also inner zone borderline for the next zone 60(3). Each zone 60(i) has a radial size ΔRi defined as the radial distance between the radius R(i+1) of its outer zone borderline 61(i+1) and the radius R(i) of its inner zone borderline 61(i), i.e. ΔRi=R(i+1)−R(i).

It is noted that the division into zones is not a physical division. Typically, the control circuit 10 is provided with a zone memory 16, which contains information on the disc zones 60. Conveniently, the zone memory 16 may contain a list of radii R(i) of all zone borderlines 61(i).

The control circuit 10 of the disc drive 1 may be designed to define the division into zones, i.e. the contents of the zone memory 16, each time when a new disc is entered, or each time when a read/write command is received, or as part of a start-up procedure. However, it is also possible that the disc drive manufacturer has pre-defined disc zones, i.e. that the contents of the zone memory 16 is fixed.

On the other hand, it is also possible that information relating to the definition of disc zones, such as a list of radii R(i) of all zone borderlines 61(i), is stored in a predefined portion of the storage disc 2, and that the disc drive is designed to use this information, or to copy this information to its zone memory 16 when a new disc is entered.

As mentioned before, recalibration processes are known per se, and the present invention is not directed to improving a recalibration process as such. In fact, known per se recalibration processes may be applied when implementing the present invention; therefore, recalibration processes as such will not be explained in further detail here. The present invention relates specifically to the timing of the recalibration processes. According to an important aspect of the present invention, a recalibration process is initiated when reaching a new zone. Normally, when a writing process or reading process follows the track, from inside to outside, reaching a new zone is equivalent to crossing the outer zone radius of the current zone. Thus, assuming that a writing process or reading process is currently taking place in zone 60(2), a recalibration process would be initiated when radius R3 would be crossed to reach the next zone 60(3). However, it is noted that a jump from somewhere in zone 60(2) to somewhere in zone 60(3) (or to any other zone) would also initiate a recalibration process. Thus, reaching a new zone, i.e. reaching a position outside the zone where writing/reading is currently taking place, is considered to be an indication that it would be desirable to execute a recalibration process.

In view of typical aspects of a manufacturing process, it is expected that, in an inner region of the disc, fewer recalibration processes are sufficient as compared to an outer region of the disc. Therefore, in accordance with a further important aspect of the present invention, the radial size ΔR of a zone in an inner region of the disc is larger than the radial size ΔR of a zone in an outer region of the disc.

In FIG. 3, the disc 2 has an inner disc region 62, in which all zones 60 mutually have substantially the same radial size ΔR(62), which is relatively large. The disc 2 further has an outer disc region 64, in which all zones 60 mutually have substantially the same radial size ΔR(64), which is relatively small. More particularly, the radial size ΔR(64) of zones 60 in the outer disc region 64 is smaller than the radial size ΔR(62) of zones 60 in the inner disc region 62.

It is noted that it is not necessary that there are only two zones. In FIG. 3, the disc 2 has an intermediate zone 63 between inner disc region 62 and outer disc region 64. In the intermediate zone 63, all zones 60 mutually have substantially the same radial size ΔR(63), which is smaller than the radial size ΔR(62) of zones 60 in the inner disc region 62 but larger than the radial size ΔR(64) of zones 60 in the outer disc region 64.

It is further noted that it is not necessary that all zones within one disc region have the same size. For instance, the disc may have a region in which the radial size of a first zone is always smaller than the radial size of a second zone directly adjacent to the first zone at the inner side thereof.

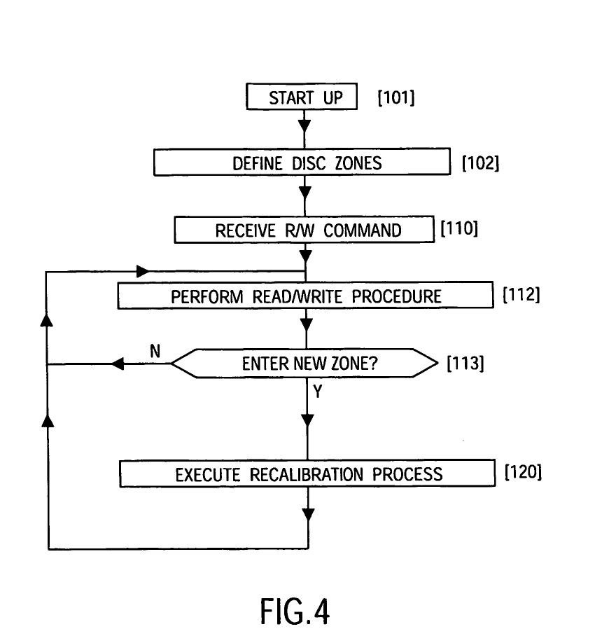

In one implementation of the present invention, a recalibration process starts immediately at a recalibration due time. In such case, the moment of reaching a new zone is the same as the starting time of the recalibration process. One examples of this implementation will be explained with reference to FIG. 4.

FIG. 4 is a flow diagram schematically illustrating one method of determining recalibration timing in accordance with the present invention. After start-up [step 101], disc zones 60 are defined [step 102], e.g. by defining a table of values R1, R2, R3 etc for borderline tracks between subsequent zones. It is noted that the zones may be pre-defined, i.e. that the disc drive has such table of values stored in a memory not shown in the figures, so that step 102 may be considered as being performed before start-up.

When a read command or write command is received [step 110] at time t0, the read/write procedure [step 112] starts. During the read/write procedure, it is checked whether the read/write procedure has entered a new disc zone [step 113]. If so, a recalibration process is executed [step 120].

After completion of the recalibration process, the read/write procedure continues and the process is repeated, indicated as a jump back to step 112.

In another implementation of the present invention, a recalibration process does not necessarily start immediately at the moment when a new zone is reached. First, it is checked whether the read/write process should be continued and the recalibration process should be postponed until a more suitable moment. In such case, the moment when a new zone is reached marks the beginning of a check for recalibration permission conditions, while the actual recalibration process only starts when all recalibration permission conditions are fulfilled. It may even be that the actual recalibration process does not start at all, because at least one of the recalibration permission conditions is not fulfilled.

By way of example of a recalibration permission condition, it may be that the disc drive is currently writing data from a data buffer (in a writing mode), and that the flow of data may not be disturbed until the buffer is empty. Or, it may be that, in a reading mode, the disc drive is outputting data to the host from a buffer which is almost empty and which should first be filled again in order to assure an undisturbed flow of data to the host.

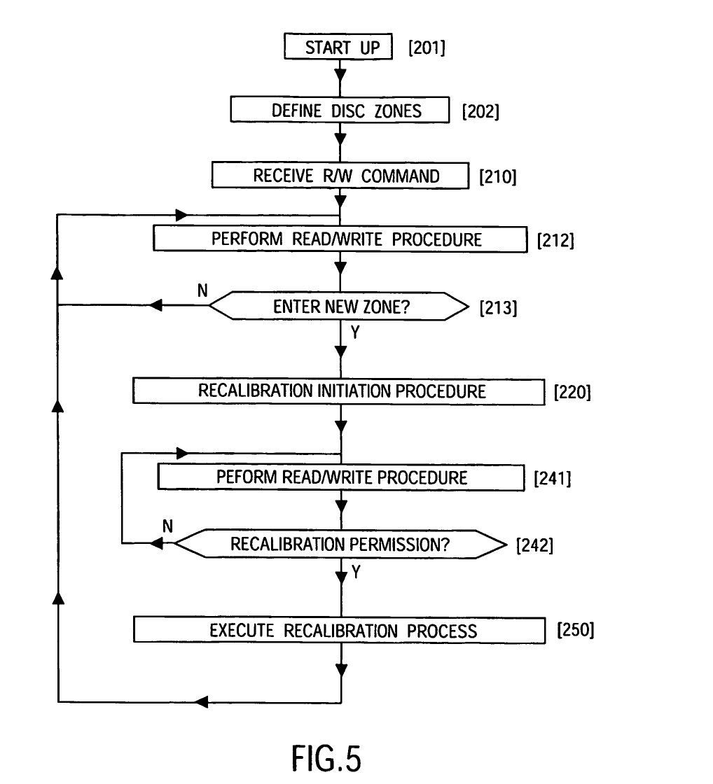

One example of this implementation will be explained with reference to FIG. 5.

FIG. 5 is a flow diagram schematically illustrating one method of determining recalibration timing in accordance with the present invention. After start-up [step 201], disc zones 60 are defined [step 202], e.g. by defining a table of values R1, R2, R3 etc for borderline tracks between subsequent zones. As noted before, the zones may be pre-defined, so that step 202 may be considered as being performed before start-up.

When a read command or write command is received [step 210] at time t0, the read/write procedure [step 212] starts. During the read/write procedure, it is checked whether the read/write procedure has entered a new disc zone [step 213]. If so, a recalibration initiation procedure is executed [step 220].

After this recalibration initiation procedure, the write/read procedure continues [step 241], during which the recalibration permission conditions are checked [step 242]. Only when all recalibration permission conditions are fulfilled, a recalibration process is executed [step 250]. Thus, the actual start of the recalibration process is later than the moment when a new disc zone is entered.

After completion of the recalibration process, the read/write procedure continues and the process is repeated, indicated as a jump back to step 212.

In the recalibration process mentioned above, i.e. the steps 120 or 250 of the above-described examples, at least one location-dependent parameter is calibrated. In fact, it is possible that for each individual location-dependent parameter an individual timing procedure is executed. However, it is preferred that in the recalibration process all location-dependent parameters are calibrated. It is even more preferred that in the recalibration process all calibrateable parameters are calibrated, i.e. that the same calibrations are performed as during the start-up procedure.

FIG. 2 schematically shows a diagram which illustrates a possible embodiment of the control circuit 10 in somewhat more detail. Specifically, in this embodiment, the control circuit 10 comprises a data engine system 20 and a data processing system 30. The data engine system 20, hereinafter simply indicated as “engine”, provides an interface between disc drive apparatus and disc, as it handles all incoming and outgoing communication between disc drive 1 and disc 2.

The data processing system 30, hereinafter simply indicated as “processor”, processes the data present in incoming and outgoing signals S_{R} and S_{W} from and to the disc, respectively, and processes the data for communication to and from a host system such as a PC, respectively.

In such design, the recalibration initiation procedure (i.e. step 220 in the above example) and the recalibration process (i.e. steps 120 or 250 in the above examples) may be executed by the data engine system 20, whereas the recalibration permission conditions are handled by the processor 30. The recalibration initiation procedure may comprise a step of the engine 20 sending a recalibration request signal to the processor 30. When the processor 30 finds that all recalibration permission conditions are fulfilled, it may send a recalibration permission signal to the engine 20, which, upon receiving this recalibration permission signal, will enter a calibration mode (i.e. steps 120 or 250 in the above examples).

It should be clear to a person skilled in the art that the present invention is not limited to the exemplary embodiments discussed above, but that various variations and modifications are possible within the protective scope of the invention as defined in the appending claims.

For instance, the present invention has been explained in the context of optical storage discs. However, the gist of the present invention is not restricted to optical storage discs, but is generally applicable to storage devices in general.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, etc.

1. Method for timing multiple recalibration processes in a storage write/read apparatus (1) when writing/reading information into/from a storage medium (2), wherein the recalibration processes are executed more frequently when writing/reading in a region (64) close to the outer disc radius than when writing/reading in a region (62) close to the inner disc radius.

2. Method according to claim 1, wherein at least one location-dependent parameter is recalibrated in the recalibration processes.

3. Method according to claim 1, wherein some parameters are calibrated during a start-up phase, and wherein the same parameters are also recalibrated in the recalibration processes.

4. Method according to claim 1, the method comprising the step of defining disc zones (60), each disc zone (60(i)) having a radial size (ΔR(i)), wherein the radial sizes (ΔR(64)) of disc zones (60) in a region (64) close to the outer disc radius are smaller than the radial sizes (ΔR(62)) of disc zones (60) in a region (62) closer to the centre of the disc (2);
the method further comprising the step of checking when the read/write procedure enters a new disc zone (60).

5. Method according to claim 4, wherein a recalibration process is started substantially immediately on entry of a new disc zone (60).

6. Method according to claim 4, wherein, on entry of a new disc zone (60), a check is made regarding predetermined recalibration permission conditions, and the start of an actual recalibration process is postponed until such time when all said predetermined recalibration permission conditions are fulfilled.

7. Method according to claim 6, wherein the write/read operation is continued until the start of an actual recalibration process.

8. Storage write/read apparatus (1) for writing/reading information into/from a storage medium (2), the apparatus being designed for performing the method according to claim 1.

9. Storage write/read apparatus (1) according to claim 8, the apparatus being a disc drive apparatus for writing/reading information into/from a storage disc (2), for instance an optical storage disc.

10. Storage write/read apparatus (1) according to claim 8, the apparatus comprising a zone memory (16) containing information regarding the definition of disc zones (60).

11. Storage write/read apparatus (1) according to claim 10, wherein said zone memory (16) contains a list of radii (R(i)) of zone borderlines (61(i)).

12. Storage write/read apparatus (1) according to claim 10, wherein each disc zone (60(i)) as defined by the information in said zone memory (16) has a radial size (ΔR(i)), the radial sizes (ΔR(64)) of disc zones (60) in a region (64) close to the outer disc radius being smaller than the radial sizes (ΔR(62)) of disc zones (60) in a region (62) closer to the centre of the disc (2).

13. Storage write/read apparatus (1) according to claim 10, the apparatus further comprising a control circuit (10) designed to perform multiple recalibration processes during a write or read process;
wherein the control circuit (10) is designed to consult said zone memory (16) when performing the step of checking whether the read/write procedure enters a new disc zone (60).

14. Storage medium (2), containing information regarding the definition of disc zones (60) in a predefined portion of its storage space;
wherein each disc zone (60(i)) as defined by the information in said predefined portion of storage space has a radial size (ΔR(i)), the radial sizes (ΔR(64)) of disc zones (60) in a region (64) close to the outer disc radius being smaller than the radial sizes (ΔR(62)) of disc zones (60) in a region (62) closer to the centre of the disc (2).

15. Storage write/read apparatus (1) for writing/reading information into/from a storage medium (2) containing information regarding the definition of disc zones (60) in a predefined portion of its storage space;
wherein each disc zone (60(i)) as defined by the information in said predefined portion of storage space has a radial size (ΔR(i)), the radial sizes (ΔR(64)) of disc zones (60) in a region (64) close to the outer disc radius being smaller than the radial sizes (ΔR(62)) of disc zones (60) in a region (62) closer to the centre of the disc (2), the apparatus being designed for performing the method according to claim 1;
the apparatus comprising a control circuit (10) designed to perform multiple recalibration processes during a write or read process;
wherein the control circuit (10) is designed to consult said information from the storage medium (2) when performing the step of checking whether the read/write procedure enters a new disc zone (60).

16. Storage write/read apparatus according to claim 15, the apparatus comprising a zone memory (16) for containing information regarding the definition of disc zones (60);
wherein the control circuit (10) is designed to read said information from the storage medium (2) and store said information into said zone memory (16).

17. Storage write/read apparatus (1) for writing/reading information into/from a storage medium (2), the apparatus being designed for performing the method according to claim 6, the apparatus comprising a control circuit (10) designed to perform multiple recalibration processes during a write or read process;
the apparatus comprising a data engine system (20) and a data processing system (30) in data communication with each other;
wherein the data engine system is designed, in a reading mode, for receiving read signals (S_{R}), deriving data signals from the read signals, and communicating the data signals to the data processing system, and in a writing mode, for receiving data signals from the data processing system and generating write signals (S_{W});
wherein the data processing system is designed, in a reading mode, for receiving data signals from the data engine system and processing the data for communication to a host system (H), and in a writing mode, for communication with a host system, processing data signals in the communication signals received from the host system, and communicating data signals to the data engine system;
wherein the data engine system is designed for checking when the read/write procedure enters a new disc zone (60), and wherein the data processing system is designed for determining the recalibration permission conditions.
